(19) United States
(12) Patent Application Publication
(10) Pub. No.: US 2020/0323040 A1
(43) Pub. Date: Oct. 8, 2020

(54) ELECTRICAL RESISTOR, HONEYCOMB STRUCTURE, AND ELECTRIC HEATING CATALYTIC DEVICE

(71) Applicant: DENSO CORPORATION, Kariya-city (JP)

(72) Inventors: Takehiro TOKUNO, Kariya-city (JP); Kazuki HIRATA, Kariya-city (JP); Yasushi TAKAYAMA, Kariya-city (JP)

(21) Appl. No.: 16/905,113

(22) Filed: Jun. 18, 2020

Related U.S. Application Data
(63) Continuation of application No. PCT/JP2018/045638, filed on Dec. 12, 2018.

(30) Foreign Application Priority Data
Dec. 19, 2017 (JP) 2017-243081

(51) Int. Cl. H05B 3/12; F01N 3/20; F01N 3/28; H01C 7/00; B01J 35/10

(52) U.S. Cl. CPC H05B 3/12; F01N 3/2026; F01N 3/2803; B01J 35/108; B01J 35/1033; B01J 35/1052; H01C 7/00

(57) ABSTRACT

An electrical resistor includes borosilicate particles, Si-containing particles, and pore parts. The pore parts are constituted by gaps between the borosilicate particles and the Si-containing particles and surround the borosilicate particles and the Si-containing particles. A honeycomb structure includes the electrical resistor. An electric heating catalytic device has the honeycomb structure.

### CROSS-REFERENCE TO RELATED APPLICATION

The present application is a continuation application of International Application No. PCT/JP2018/045638 filed on Dec. 12, 2018, which claims priority to Japanese Patent Application No. 2017-243081 filed on Dec. 19, 2017. The contents of these applications are incorporated herein by reference in their entirety.

### BACKGROUND

The present disclosure relates to an electrical resistor, a honeycomb structure, and an electric heating catalytic device.

Conventionally, electrical resistors have been used for electrical heating in various fields. For example, in the vehicle field, electric heating catalytic devices are publicly known in which a honeycomb structure that carries a catalyst is constituted by an electrical resistor such as SiC and the honeycomb structure generates heat by electrical heating.

### SUMMARY

An aspect of the present disclosure is an electrical resistor including:

borosilicate particles;

Si-containing particles; and

pore parts constituted by gaps between the borosilicate particles and the Si-containing particles and surrounding the borosilicate particles and the Si-containing particles.

Another aspect of the present disclosure is a honeycomb structure including the electrical resistor.

Still another aspect of the present disclosure is an electric heating catalytic device including the honeycomb structure.

### BRIEF DESCRIPTION OF THE DRAWINGS

The above and other objects, characteristics, and advantages of the present disclosure will be further clarified in the following detailed description with reference to the accompanying drawings, in which:

FIG. 1 is an explanatory diagram schematically illustrating a microstructure of an electrical resistor according to the first embodiment;

FIG. 2 is an explanatory diagram schematically illustrating a honeycomb structure according to the second embodiment;

FIG. 3 is an explanatory diagram schematically illustrating an electric heating catalytic device according to the third embodiment;

FIG. 4 is a scanning electron microscope (SEM) image of Sample 1 in Example 1;

FIG. 5 is a scanning electron microscope (SEM) image of Sample 1C in Example 1;

FIG. 6 is a graph illustrating the relation between temperature and electrical resistivity for Samples 1 and 1C in Example 1;

FIG. 7 is the pore diameter distribution of Samples 1 and 1C in Example 1;

FIG. 8 is a graph illustrating the relation between temperature and electrical resistivity for Samples 2 and 3 (fired at 1250° C.) in Example 2; and

FIG. 9 is a graph illustrating the relation between temperature and electrical resistivity for Samples 4 to 6 (fired at 1300° C.) in Example 2.

### DETAILED DESCRIPTION OF THE PREFERRED EMBODIMENTS

Preceding patent literature JP H5-234704 A discloses an electrical resistor in which a ceramic structural material composed mainly of aluminosilicate contains 5 to 60 mass % Si and 5 to 50 mass % SiC. JP H5-234704 A also describes a technique of adding a glass component to the electrical resistor, eluting the glass component onto the surface during firing at 1000 to 1400° C., and forming an insulating glass coat on the surface of the electrical resistor.

With respect to the electrical resistivity of an electrical resistor, there are optimal values of current and voltage that enable the electrical resistor to efficiently generate heat by electrical heating. However, the electrical resistivity of many electrical resistors, as typified by SiC, is highly temperature dependent, and optimal values of current and voltage vary in accordance with the temperature of the electrical resistor. Therefore, electrical resistors having low temperature dependence of electrical resistivity are required. In addition, in order to enable an electrical resistor to efficiently generate heat by electrical heating, it is important to reduce the heat capacity of the electrical resistor.

For reducing the weight of a honeycomb structure, it is preferable that the bulk density of the electrical resistor be low. Furthermore, it is important for an electrical resistor that is applied as a material for a honeycomb structure to have superior catalyst carrying performance.

An object of the present disclosure is to provide an electrical resistor which has low temperature dependence of electrical resistivity and can have low bulk density, low heat capacity, and improved catalyst carrying performance, a honeycomb structure using the electrical resistor, and an electric heating catalytic device using the honeycomb structure.

An aspect of the present disclosure is an electrical resistor including:

borosilicate particles;

Si-containing particles; and

pore parts constituted by gaps between the borosilicate particles and the Si-containing particles and surrounding the borosilicate particles and the Si-containing particles.

Another aspect of the present disclosure is a honeycomb structure including the electrical resistor.

Still another aspect of the present disclosure is an electric heating catalytic device including the honeycomb structure.

The above-mentioned electrical resistor has borosilicate particles and Si-containing particles, and thus can have low temperature dependence of electrical resistivity. The above-mentioned electrical resistor also has pore parts constituted by gaps between borosilicate particles and Si-containing particles and surrounding borosilicate particles and Si-containing particles, and thus can have lower bulk density and heat capacity than an electrical resistor in which gaps between borosilicate particles and Si-containing particles are filled with glass. In addition, due to the pore parts, unevenness is generated on a surface of the above-mentioned electrical resistor. Therefore, the above-mentioned electrical resistor can have improved performance of carrying a catalyst such as an exhaust gas purification catalyst.

The above-mentioned honeycomb structure includes the above-mentioned electrical resistor. Therefore, the above-mentioned honeycomb structure is unlikely to have uneven temperature distribution in the structure during electrical heating, and unlikely to crack due to differences in thermal expansion. In addition, the above-mentioned honeycomb structure is likely to generate heat rapidly at low temperature during electrical heating. The above-mentioned honeycomb structure is also advantageously lightweight. The above-mentioned honeycomb structure can also carry an exhaust gas purification catalyst easily on its surface.

The above-mentioned electric heating catalytic device has the above-mentioned honeycomb structure. Because the honeycomb structure is unlikely to crack during electrical heating, the above-mentioned electric heating catalytic device can have improved reliability. In the above-mentioned electric heating catalytic device, the honeycomb structure can generate heat rapidly at low temperature during electrical heating, which is advantageous in activating the catalyst rapidly. The above-mentioned electric heating catalytic device is also advantageously lightweight because the honeycomb structure is lightweight.

### First Embodiment

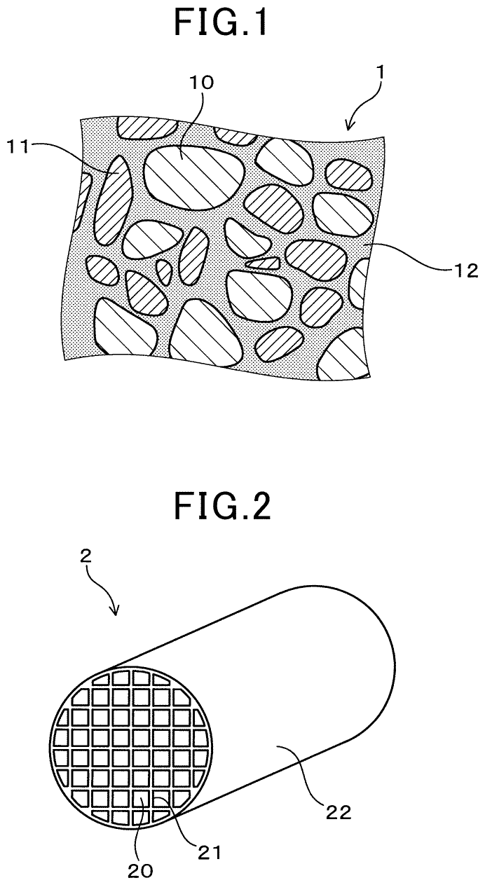

An electrical resistor according to the first embodiment will be described using FIG. 1. As illustrated in FIG. 1, the electrical resistor according to the present embodiment includes borosilicate particles 10, Si-containing particles 11, and pore parts 12.

The borosilicate particles 10 may be amorphous or may be crystalline. The borosilicate particles 10 can contain, for example, aluminum (Al) atoms as well as atoms such as boron (B), silicon (Si), and oxygen (O). In this case, the borosilicate particles 10 are aluminoborosilicate particles. This composition can ensure that the electrical resistor 1 has low temperature dependence of electrical resistivity and can have low bulk density, low heat capacity, and improved catalyst carrying performance. In addition, the borosilicate particles 10 can contain alkali metal atoms such as Na and K and/or alkaline-earth metal atoms such as Mg and Ca (hereinafter, alkali metal atoms and alkaline-earth metal atoms may be collectively referred to as alkali atoms). One or more types of alkali atoms may be contained.

The borosilicate particles 10 can contain 0.1 mass % or more and 5 mass % or less of B atoms. This composition is advantageous in facilitating the reduction of the temperature dependence of electrical resistivity, for example.

In view of facilitating the reduction of the electrical resistance of the electrical resistor 1, for example, the content of B atoms can be preferably 0.2 mass % or more, more preferably 0.3 mass % or more, much more preferably 0.5 mass % or more, still more preferably 0.6 mass % or more, even more preferably 0.8 mass % or more, and, in view of reducing the temperature dependence of electrical resistivity and making sure that the electrical resistivity exhibits the PTC property (which means that the electrical resistivity increases as the temperature becomes higher), for example, yet more preferably 1 mass % or more. In consideration of the fact that there is a limit on the amount of doping of B atoms to silicate and that undoped B atoms are unevenly distributed in the material as B₂O₃, i.e. an insulator, to cause a reduction in conductivity, for example, the content of B atoms can be preferably 4 mass % or less, more preferably 3.5 mass % or less, and even more preferably 3 mass % or less.

The borosilicate particles 10 can contain 5 mass % or more and 40 mass % or less of Si atoms. This composition facilitates the reduction of the temperature dependence of electrical resistivity.

In view of ensuring the above-mentioned effects and raising the softening point of the borosilicate particles 10, for example, the content of Si atoms can be preferably 7 mass % or more, more preferably 10 mass % or more, and even more preferably 15 mass % or more. In view of ensuring the above-mentioned effects, for example, the content of Si atoms can be preferably 30 mass % or less, more preferably 26 mass % or less, and even more preferably 24 mass % or less.

The borosilicate particles 10 can contain 40 mass % or more and 85 mass % or less of O atoms. This composition facilitates the reduction of the temperature dependence of electrical resistivity.

In view of ensuring the above-mentioned effects, for example, the content of O atoms can be preferably 45 mass % or more, more preferably 50 mass % or more, even more preferably 55 mass % or more, and still more preferably 60 mass % or more. In view of ensuring the above-mentioned effects, for example, the content of O atoms can be preferably 82 mass % or less, more preferably 80 mass % or less, and even more preferably 78 mass % or less.

In a case where the borosilicate particles 10 are aluminoborosilicate particles, the borosilicate particles 10 can contain 0.5 mass % or more and 10 mass % or less of Al atoms. This composition facilitates the reduction of the temperature dependence of electrical resistivity.

In view of ensuring the above-mentioned effects, for example, the content of Al atoms can be preferably 1 mass % or more, more preferably 2 mass % or more, and even more preferably 3 mass % or more. In view of ensuring the above-mentioned effects, for example, the content of Al atoms can be preferably 8 mass % or less, more preferably 6 mass % or less, and even more preferably 5 mass % or less.

In a case where the borosilicate particles 10 contain alkali atoms, the total content of at least one type of alkali atom selected from the group consisting of Na, Mg, K, and Ca in the borosilicate particles 10 can be 2 mass % or less. According to this composition, in case of firing under an atmosphere containing oxygen gas, reaction of alkali atoms eluted and segregated onto the surface of the electrical resistor 1 with oxygen in the atmosphere and forming an insulating glass coat can be easily suppressed even when a gas barrier coat that cuts off oxygen gas is not formed. According to this composition, when using the electrical resistor 1 as a material for a conductive honeycomb structure, removal an insulating glass coat prior to forming an electrode on the surface of the honeycomb structure can be omitted, which improves the manufacturability of the honeycomb structure. In this case, in view of preventing the formation of an insulating glass coat, for example, the total content of alkali atoms can be preferably 1.5 mass % or less, more preferably 1.2 mass % or less, and even more preferably 1 mass % or less.

In consideration of the above-mentioned respects, it is preferable that the total content of alkali atoms be as low as possible. However, alkali atoms are elements that tends to contaminate the borosilicate particles 10 from raw materials for the electrical resistor 1. Therefore, it is costly and time consuming to completely remove alkali atoms from the raw materials such that the borosilicate particles 10 do not contain alkali atoms. Thus, the total content of alkali atoms can be preferably 0.01 mass % or more, more preferably 0.05 mass % or more, even more preferably 0.1 mass % or more, and still more preferably 0.2 mass % or more. Note that it is possible to reduce the content of alkali atoms by using boric acid as a raw material for the electrical resistor 1 instead of using borosilicate glass that contains alkali atoms, which will be described in detail in Examples. Here, in a case where borosilicate contains one type of alkali atom, “the total content of alkali atoms” means the mass percentage of the one type of alkali atom. In a case where the borosilicate particles 10 contain multiple types of alkali atoms, “the total content of alkali atoms” means the sum (mass %) of all the contents (mass %) of the multiple types of alkali atoms.

Note that the content of each type of atom in the above-mentioned borosilicate particles 10 can be selected from the above-mentioned ranges such that the total content becomes 100 mass %. Examples of atoms that can be contained in the borosilicate particles 10 can include Fe, C, and the like in addition to the above-mentioned atoms. Among the above-mentioned atoms, the content of Si, O, Al, and alkali atoms is measured using an electron-beam microanalyzer (EPMA) analysis device. Among the above-mentioned atoms, the content of B is measured using an inductively coupled plasma (ICP) analysis device. However, the ICP analysis produces the B content relative to the entire electrical resistor 1. Therefore, the obtained measurement result is converted to the B content relative to the borosilicate particles 10.

The Si-containing particles 11 are electron-conductive particles that contain Si atoms. Therefore, the Si-containing particles 11 do not contain SiO₂ particles or the like. Specific examples of Si-containing particles can include Si particles, Fe—Si-based particles, Si—W-based particles, Si—C-based particles, Si—Mo-based particles, Si—Ti-based particles, and the like. One or more types of Si-containing particles may be contained. This composition is advantageous in that Si-containing particles, namely electron-conductive particles, facilitate electrical bridging between the borosilicate particles 10. Among them, it is preferable that Si particles, Fe—Si-based particles, or the like be contained because they have a relatively low melting point and are unlikely to cause the pest phenomenon. Note that the pest phenomenon is a phenomenon observed in MoSi₂ or WSi₂ in which a polycrystalline body transforms into a powder due to oxidation at relatively low temperatures of about 500° C.

In addition to the Si-containing particles 11, the electrical resistor 1 can contain, as necessary, one or more types of fillers, materials that reduce the thermal expansion, materials that increase the thermal conductivity, materials that enhance the strength, kaolin, and the like.

The pore parts 12 are constituted by the gaps between the borosilicate particles 10 and the Si-containing particles 11 and surrounds the borosilicate particles 10 and the Si-containing particles 11. That is, the pore parts 12 are constituted by the gaps formed at the interface between the borosilicate particles 10 and the Si-containing particles 11, and is different from a void that can be formed when the electrical resistor 1 is manufactured. Note that a cavity with a maximum outer diameter of 5 μm or more is usually regarded as a void. The pore parts 12 may be continuous or discontinuous. The pore parts 12 need not completely surround the entire periphery of the borosilicate particles 10 and the Si-containing particles 11. In the example illustrated in FIG. 1, a plurality of borosilicate particles 10 and a plurality of Si-containing particles 11 are surrounded by the pore parts 12.

The cumulative pore volume of the electrical resistor 1 can be 0.05 ml/g or more. This composition can ensure the structure in which the pore parts 10 exist at the interface between the borosilicate particles 10 and the Si-containing particles 11. If the cumulative pore volume of the electrical resistor 1 is less than 0.05 ml/g, it is difficult to reduce the bulk density and the heat capacity for lack of the pore parts 10. If the cumulative pore volume of the electrical resistor 1 is less than 0.05 ml/g for the reason that most pore parts are filled with the glass component melted during firing, for example, the anchor effect may be weakened when the catalyst is carried, and the catalyst may peel off due to the hot/cold cycle. Note that the cumulative pore volume of the electrical resistor 1 is a value that is measured in compliance with JIS R1655:2003 “Test methods for pore size distribution of fine ceramic green body by mercury porosimetry”. Note that the measurement is conducted on the surface of the electrical resistor 1. The mean particle diameter of the borosilicate particles 10 can be preferably 0.5 μm or more, more preferably 1 μm or more, and even more preferably 2 μm or more in consideration of the fact that too small diameters can cause an increase in the area of grain boundaries and raise the electrical resistance. The mean particle diameter of the borosilicate particles 10 can be preferably 30 μm or less, more preferably 20 μm or less, and even more preferably 15 μm or less in consideration of the fact that too large diameters can cause a problem in reducing the wall thickness of the honeycomb structure.

The mean particle diameter of the Si-containing particles 11 can be preferably 0.5 μm or more, more preferably 1 μm or more, and even more preferably 2 μm or more in consideration of the fact that too small diameters can cause an increase in the area of grain boundaries and raise the electrical resistance. The mean particle diameter of the Si-containing particles 11 can be preferably 30 μm or less, more preferably 20 μm or less, and even more preferably 15 μm or less in consideration of the fact that too large diameters can cause a problem in reducing the wall thickness of the honeycomb structure.

The mean particle diameter of the borosilicate particles 10 and the Si-containing particles 11 is measured in the following manner. A cross-section perpendicular to the surface of the electrical resistor 1 is observed by EPMA. The element mapping of the observed region is measured, and the positions of the borosilicate particles 10 and the Si-containing particles 11 are identified. The maximum outer diameter of each of the borosilicate particles 10 in the observed region is computed. The mean of the obtained maximum outer diameters is set as the mean particle diameter of the borosilicate particles 10. Similarly, the maximum outer diameter of each of the Si-containing particles 11 in the observed region is computed. The mean of the obtained maximum outer diameters is set as the mean particle diameter of the Si-containing particles 11. Note that particle diameters can be analytically calculated using image analysis software (WinROOF produced by Mitani Corporation).

The bulk density of the electrical resistor 1 can be preferably 1 g/cm³ or more, more preferably 1.1 g/cm³ or more, and even more preferably 1.2 g/cm³ or more in view of easily securing the deflection strength required for retaining the shape, for example. The bulk density of the electrical resistor 1 can be preferably 2 g/cm³ or less, more preferably 1.8 g/cm³ or less, and even more preferably 1.6 g/cm³ or less in view of reducing the heat capacity, for example.

The electrical resistor 1 can have an electrical resistivity of 0.0001 Ω·m or more and 1 Ω·m or less and an electrical resistance increase rate of 0/K or more and 5.0×10⁻⁴/K or less in the temperature range of 25 to 500° C. These properties can ensure that the temperature dependence of the electrical resistor 1 is so low that the electrical resistor 1 is unlikely to have uneven internal temperature distribution during electrical heating, and unlikely to crack due to a difference in thermal expansion. These properties are also advantageous in that the electrical resistor 1 can generate heat rapidly at lower temperature during electrical heating, which is why the electrical resistor 1 is useful as a material for a honeycomb structure required to be heated rapidly for activating the catalyst rapidly.

The electrical resistivity of the electrical resistor 1 varies depending on, for example, specifications required for the system that uses the electrical resistor 1, but can be, for example, preferably 0.5 Ω·m or less, more preferably 0.3 Ω·m or less, even more preferably 0.1 Ω·m or less, still more preferably 0.05 Ω·m or less, even more preferably 0.01 Ω·m or less, yet more preferably less than 0.01 Ω·m, and most preferably 0.005 Ω·m or less in view of reducing the electrical resistance of the electrical resistor 1, for example. The electrical resistivity of the electrical resistor 1 can be preferably 0.0002 Ω·m or more, more preferably 0.0005 Ω·m or more, and even more preferably 0.001 Ω·m or more in view of increasing the amount of heat generation during electrical heating, for example. This property makes the electrical resistor 1 suitable for a material for the honeycomb structure used in an electric heating catalytic device.

The electrical resistance increase rate of the electrical resistor 1 can be preferably 0.001×10⁻⁶/K or more, more preferably 0.01×10⁻⁶/K or more, and even more preferably 0.1×10⁻⁶/K or more in view of facilitating the prevention of uneven temperature distribution due to electrical heating, for example. In consideration of the fact that an electric circuit has an optimal electrical resistance value for electrical heating, the electrical resistance increase rate of the electrical resistor 1 should not ideally change. Therefore, the electrical resistance increase rate of the electrical resistor 1 can be preferably 100×10⁻⁶/K or less, more preferably 10×10⁻⁶/K or less, and even more preferably 1×10⁻⁶/K or less.

Note that the electrical resistivity of the electrical resistor 1 is the mean of measurement values (n=3) measured with four-terminal sensing. After the electrical resistivity of the electrical resistor 1 is measured using the above method, the electrical resistance increase rate of the electrical resistor 1 can be calculated using the following calculation method. First, the electrical resistivity is measured at three points: 50° C., 200° C., and 400° C. Then, the electrical resistivity at 50° C. is subtracted from the electrical resistivity at 400° C. The derived value is then divided by the temperature difference 350° C. between 400° C. and 50° C., whereby the electrical resistance increase rate can be calculated.

The electrical resistor 1 can be manufactured, for example, in the following manner, which is a non-limiting example of a manufacturing method.

Boric acid, Si-atom-containing material, and kaolin are mixed. The use of boric acid, which contains almost no alkali atoms, as the boron source can reduce the content of alkali atoms in the resultant electrical resistor 1 and enhance the doping of boron to silicate. The mass ratio of boric acid can be 4 or more and 8 or less, for example. With the mass ratio of boric acid in this range, the electrical resistor 1 having low temperature dependence of electrical resistivity can be easily obtained. Note that the content of boron contained in borosilicate can be easily raised by increasing the firing temperature (described later). As more boron is doped to silicate, the resultant electrical resistor 1 can have lower electrical resistance.

Next, a binder and water are added to the mixture. For example, an organic binder such as methylcellulose can be used as the binder. The content of the binder can be about 2 mass %, for example.

Next, the obtained mixture is formed into a predetermined shape.

Next, the obtained compact is fired. Specific examples of firing conditions can be: under an inert gas atmosphere or under an atmospheric atmosphere, atmospheric pressure or less, a firing temperature of 1150 to 1350° C., and a firing time of 0.1 to 50 hours. Note that the firing atmosphere can be an inert gas atmosphere, for example, and the firing pressure can be ordinary pressure or the like. For reducing the electrical resistance of the electrical resistor 1, it is preferable that residual oxygen be reduced to prevent oxidation, which can be achieved by firing under a high-vacuum atmosphere of 1.0×10⁻⁴ Pa or better and then purging the inert gas for firing. An inert gas atmosphere can be exemplified by N₂ gas atmosphere, helium gas atmosphere, argon gas atmosphere, and the like. Before the firing, the compact can be preliminarily fired as necessary. Specific preliminary firing conditions can be: under an atmospheric atmosphere or under an inert gas atmosphere, a firing temperature of 500 to 700° C., and a firing time of 1 to 50 hours. In this manner, the electrical resistor 1 can be obtained.

The electrical resistor 1 according to the present embodiment has the borosilicate particles 10 and the Si-containing particles 11, and thus can have low temperature dependence of electrical resistivity. The electrical resistor 1 also has the pore parts 12 between the borosilicate particles 10 and the Si-containing particles 11, and thus can have lower bulk density and heat capacity than one in which the gaps between the borosilicate particles 10 and the Si-containing particles 11 are filled with glass. The electrical resistor 1 has a rough surface due to the pore parts 12. Therefore, the electrical resistor 1 can have improved performance of carrying a catalyst such as an exhaust gas purification catalyst.

### Second Embodiment

A honeycomb structure according to the second embodiment will be described using FIG. 2. Note that reference signs in the second and subsequent embodiments which are the same as those in any previous embodiment represent components or the like similar to those in the previous embodiment, unless otherwise specified.

As illustrated in FIG. 2, the honeycomb structure 2 according to the present embodiment includes the electrical resistor 1 according to the first embodiment. In the present embodiment, specifically, the honeycomb structure 2 includes the electrical resistor 1 according to the first embodiment. FIG. 2 specifically illustrates, with a honeycomb cross-sectional view perpendicular to the central axis of the honeycomb structure 2, a structure having a plurality of cells 20 adjacent to each other, cell walls 21 that form the cells 20, and an outer peripheral wall 22 that is provided on the outer periphery of the cell walls 21 to integrally hold the cell walls 21.

Note that a publicly-known structure can be applied to the honeycomb structure 2, instead of the structure illustrated in FIG. 2. In the example of FIG. 2, each of the cells 20 has a quadrangular cross-sectional shape, but each of the cells 20 may have a hexagonal cross-sectional shape.

The honeycomb structure 2 according to the present embodiment includes the electrical resistor 1 according to the first embodiment. Therefore, the honeycomb structure 2 according to the present embodiment is unlikely to have uneven temperature distribution in the structure during electrical heating, and unlikely to crack due to a difference in thermal expansion. In addition, the honeycomb structure 2 is likely to generate heat rapidly at low temperature during electrical heating. The honeycomb structure 2 is also advantageously lightweight. The honeycomb structure 2 can also carry an exhaust gas purification catalyst easily on its surface.

The honeycomb structure 2 can have a particulate collection function. Note that the particulate collection function means the function of collecting particulates contained in exhaust gas in the pore parts 12. In recent years, exhaust gas aftertreatment systems have been required to remove particulates contained in exhaust gas as well as usual exhaust gases such NOx, CO, and HC. For this reason, gasoline particle filters (GPFs) or diesel particle filters (DPFs) are mounted on exhaust gas aftertreatment systems as particulate filters. Because these filters collect particulates using porous honeycomb structures, pore control is very important for developing GPFs and DPFs. Therefore, for implementing the particulate collection function in an electric heating catalytic device having a honeycomb structure, pore structure control is important. In conventional honeycomb structures with electrical resistors, the gaps between borosilicate particles and Si-containing particles are filled with glass, which makes pore parts control difficult and makes application to GPFs and DPFs difficult. In addition, typical GPFs and DPFs are disadvantageous in that when the honeycomb structure is clogged with collected particulates due to long-term use, the clogging has to be resolved by combustion treatment using fuel injection. In contrast, the honeycomb structure 2 according to the present embodiment includes the electrical resistor 1 according to the first embodiment, and has the particulate collection function. Therefore, this configuration enables particulates collected in the pore parts 12 of the electrical resistor 1 including the honeycomb structure 2 to be combusted through electrical heating. Thus, this configuration facilitates application to GPFs and DPFs and eliminates the need for particulate combustion treatment using fuel injection, which can lead to savings in fuel.

### Third Embodiment

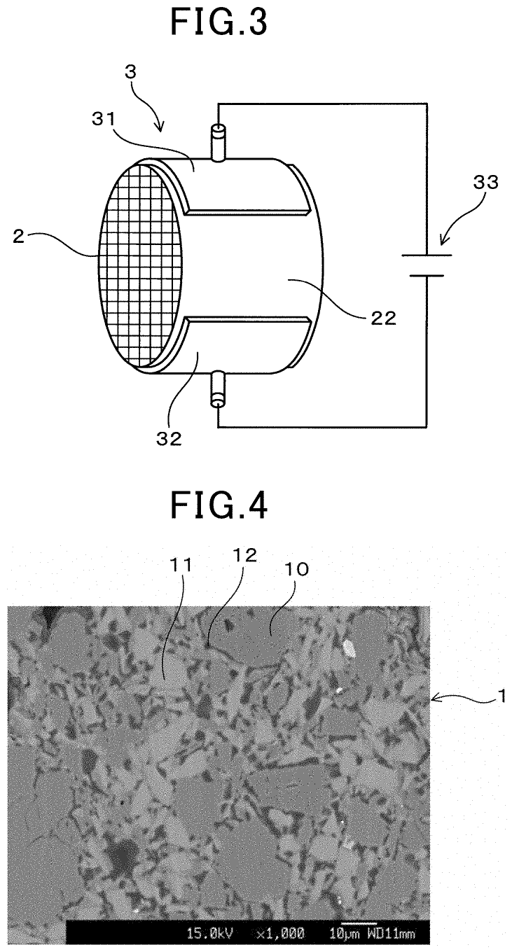

An electric heating catalytic device according to the third embodiment will be described using FIG. 3. As illustrated in FIG. 3, the electric heating catalytic device 3 according to the present embodiment has the honeycomb structure 2 according to the third embodiment. In the present embodiment, specifically, the electric heating catalytic device 3 has the honeycomb structure 2, an exhaust gas purification catalyst (not illustrated) carried on the cell walls 21 of the honeycomb structure 2, a pair of electrodes 31 and 32 arranged on the outer peripheral wall 22 of the honeycomb structure 2 such that the electrodes 31 and 32 face each other via the outer peripheral wall 22, and a voltage application unit 33 that applies voltage to the electrodes 31 and 32. Note that a publicly-known structure can be applied to the electric heating catalytic device 3, instead of the structure illustrated in FIG. 3.

The electric heating catalytic device 3 according to the present embodiment has the honeycomb structure 2 according to the second embodiment. Because the honeycomb structure 2 is unlikely to crack during electrical heating, the electric heating catalytic device 3 according to the present embodiment can have improved reliability. In the electric heating catalytic device 3, the honeycomb structure 2 can generate heat rapidly at low temperature during electrical heating, which is advantageous in activating the catalyst rapidly. The electric heating catalytic device 3 is also advantageously lightweight because the honeycomb structure 2 is lightweight.

### Example 1

### (Preparation of Samples)

### —Sample 1—

Boric acid, Si particles, and kaolin were mixed in a mass ratio of 4:42:54. Next, 2 mass % methylcellulose was added to this mixture as a binder. Water was further added, and the mixture was kneaded. Next, the obtained mixture was formed into pellets using an extrusion machine, and the pellets were subjected to primary firing. Conditions for primary firing were: a firing temperature of 700° C., a temperature elevation time of 100° C./hour, a retention time of one hour, and under an atmospheric atmosphere and ordinary pressure. After primary firing, the fired body was subjected to secondary firing. Conditions for secondary firing were: under N₂ gas atmosphere and ordinary pressure, a firing temperature of 1250° C., a firing time of 30 minutes, and a temperature elevation rate of 200° C./hour. Consequently, Sample 1 with dimensions of 5 mm×5 mm×18 mm was obtained. The EPMA measurement showed that the borosilicate particles in Sample 1 contained a total of 0.5 mass % alkali atoms (Na, Mg, K, and Ca), 22.7 mass % Si, 68.1 mass % 0, and 5.7 mass % Al. The ICP measurement showed that the borosilicate particles in Sample 1 contained 0.9 mass % B. Note that a JXA-8500F produced by JEOL Ltd. was used as the EPMA analysis device. In addition, an SPS-3520UV produced by Hitachi High-Tech Science Corporation was used as the ICP analysis device. The same applies hereinafter. —Sample 1C—Borosilicate fiberglass (mean diameter: 10 μm, mean length: 25 μm) containing Na, Mg, K, and Ca, Si particles, and kaolin were mixed in a mass ratio of 29:31:40. Next, 2 mass % methylcellulose was added to this mixture as a binder. Water was further added, and the mixture was kneaded. Next, the obtained mixture was formed into pellets using an extrusion machine, and the pellets were subjected to primary firing. Conditions for primary firing were: a firing temperature of 700° C., a temperature elevation time of 100° C./hour, a retention time of one hour, and under an atmospheric atmosphere and ordinary pressure. After primary firing, the fired body was subjected to secondary firing. Conditions for secondary firing were: under N₂ gas atmosphere and ordinary pressure, a firing temperature of 1300° C., a firing time of 30 minutes, and a temperature elevation rate of 200° C./hour. Consequently, Sample 1C with dimensions of 5 mm×5 mm×18 mm was obtained. The EPMA measurement showed that the borosilicate particles in Sample 1C contained a total of 6.4 mass % alkali atoms (Na, Mg, K, and Ca), 21.4 mass % Si, 65.4 mass % 0, and 5.1 mass % Al. The ICP measurement showed that the borosilicate particles in Sample 1C contained 0.9 mass % B.

### (SEM Observation)

A cross-section of each sample obtained was subjected to SEM observation. The samples for SEM observation were cut and polished with abrasive paper #800, and then further polished with a cross-section polisher. This is because mechanical polishing can cause clogging of the pore parts with fine powder and make the subsequent observation of the pore parts difficult to conduct appropriately. The results of the above observation are shown in FIGS. 4 and 5. As shown in FIG. 5, Sample 1C contained aluminoborosilicate particles and Si particles, but did not appear to contain pore parts constituted by the gaps between aluminoborosilicate particles and Si particles and surrounding aluminoborosilicate particles and Si particles. The reason why pore parts were not formed is that the borate glass used as a raw material was melted during firing and filled the gaps between aluminoborosilicate particles and Si particles. In FIG. 5, reference sign B represents a void. The void is a large cavity that does not surround aluminoborosilicate particles and Si particles, and is different from the above-mentioned pore parts.

In contrast, as shown in FIG. 4, Sample 1 contained aluminoborosilicate particles and Si particles. Furthermore, Sample 1 appeared to contain pore parts constituted by the gaps between aluminoborosilicate particles and Si particles and surrounding aluminoborosilicate particles and Si particles. The reason why the pore parts were formed in Sample 1, unlike in Sample 1C, is that boric acid was used as a raw material for the boron source containing almost no alkali atoms such as Na, Mg, K, and Ca, which prevented the gaps between aluminoborosilicate particles and Si particles from being filled with glass during firing. Note that the main cause of the presence of alkali atoms confirmed in Sample 1 is kaolin used as a raw material.

### (Measurement of Pore Diameter Distribution)

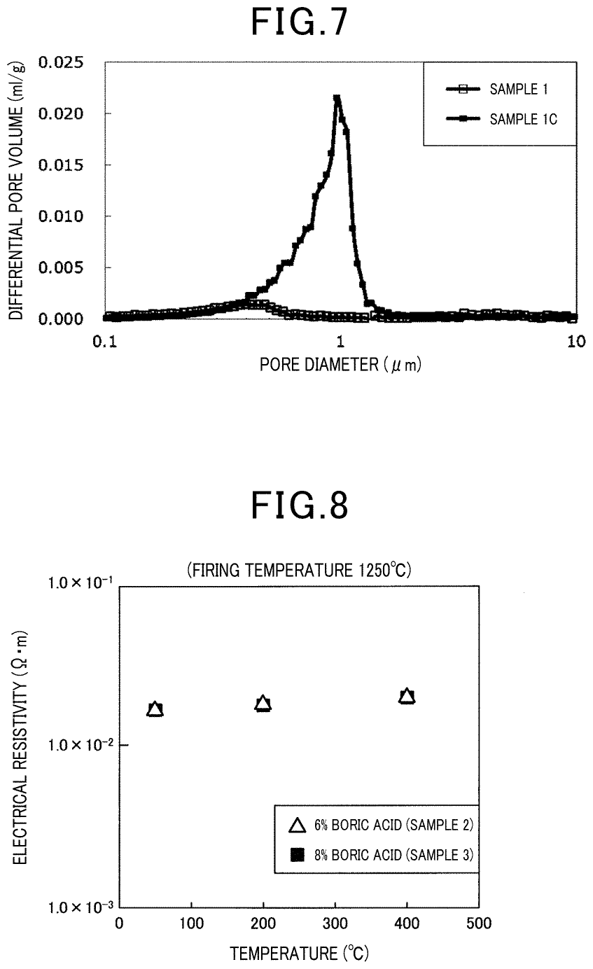

As described above, the pore diameter distribution on the surface of each sample was measured using a mercury porosimeter (“AutoPoreIV9500” produced by Shimadzu Corporation) in compliance with JIS R1655:2003. The measured pore diameter distribution of each sample is shown in FIG. 7. Note that the range of pore diameters for calculating the cumulative pore volume was 100 nm to 100 μm. The cumulative pore volume of Sample 1 was 0.220 ml/g, and the cumulative pore volume of Sample 1C was 0.032 ml/g. That is, the cumulative pore volume of Sample 1 was about 6.9 times as large as that of Sample 1C.

### (Measurement of Bulk Density)

The bulk density of each sample was measured. As a result, the bulk density of Sample 1 was 1.51 g/cm³, and the bulk density of Sample 1C was 1.93 g/cm³. That is, the bulk density of Sample 1 was about 21% lower than that of Sample 1C. In addition, a calculation based on this result showed that the heat capacity of Sample 1 was about 21% lower than that of Sample 1C with the same shape.

### (Measurement of Electrical Resistivity)

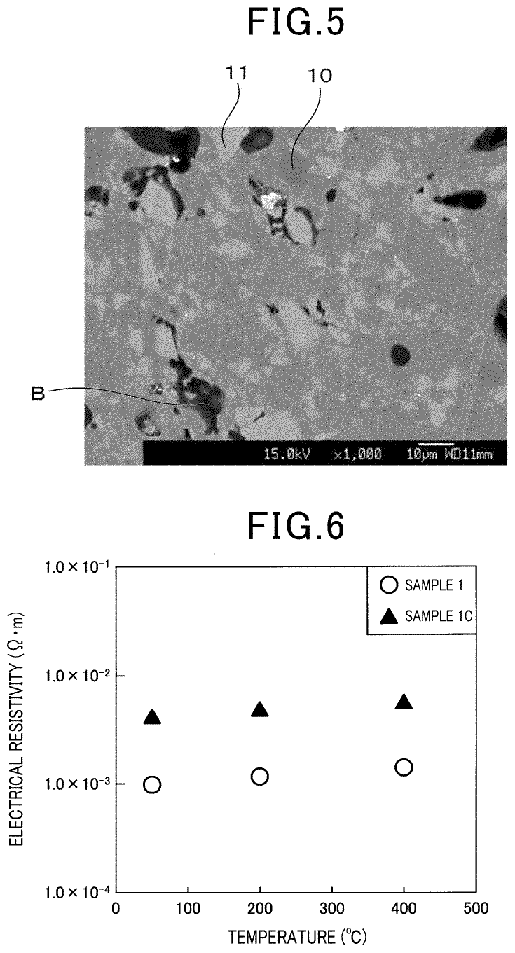

The electrical resistivity of each sample was measured. Note that the electrical resistivity of a prismatic sample piece of 5 mm×5 mm×18 mm was measured with four-terminal sensing using a thermoelectric property evaluation device (ZEM-2 produced by ULVAC RIKO, Inc.). As shown in FIG. 6, every sample piece of Sample 1 was found to have a much lower temperature dependence of electrical resistivity than SiC and have an electrical resistivity exhibiting the PTC property. In addition, Sample 1 was found to have an electrical resistivity of 0.0001 Ω·m or more and 1 Ω·m or less and an electrical resistance increase rate of 0/K or more and 5.0×10⁻⁴/K or less in the temperature range of 25 to 500° C. Note that Sample 1 exhibited the expected properties even though it was fired at a lower temperature than Sample 1C. If Sample 1 is fired at the same firing temperature as Sample 1C, the doping of boron (B) to aluminoborosilicate in Sample 1 is presumed to be enhanced, which can result in a further reduction in electrical resistivity. This is described later in Example 2.

### Example 2

### —Sample 2—

Sample 2 was obtained in the same manner as Sample 1 for Example 1 except that boric acid, Si particles, and kaolin were mixed in a mass ratio of 6:41:53 and the firing temperature was 1250° C.

### —Sample 3—

Sample 3 was obtained in the same manner as Sample 1 for Example 1 except that boric acid, Si particles, and kaolin were mixed in a mass ratio of 8:40:52 and the firing temperature was 1250° C.

### —Sample 4—

Sample 4 was obtained in the same manner as Sample 1 for Example 1 except that boric acid, Si particles, and kaolin were mixed in a mass ratio of 4:42:54 and the firing temperature was 1300° C.

### —Sample 5—

Sample 5 was obtained in the same manner as Sample 1 for Example 1 except that boric acid, Si particles, and kaolin were mixed in a mass ratio of 6:41:53 and the firing temperature was 1300° C.

### —Sample 6—

Sample 6 was obtained in the same manner as Sample 1 for Example 1 except that boric acid, Si particles, and kaolin were mixed in a mass ratio of 8:40:52 and the firing temperature was 1300° C.

Evaluations similar to those in Example 1 were performed on each sample obtained. As a result, every sample appeared to contain a structure having aluminoborosilicate particles, Si particles, and pore parts. The cumulative pore volume of every sample was 0.05 ml/g or more. The B content contained in borosilicate particles in Sample 2 was 0.8 mass %, the B content contained in borosilicate particles in Sample 3 was 1.3 mass %, the B content contained in borosilicate particles in Sample 4 was 2.1 mass %, the B content contained in borosilicate particles in Sample 5 was 1.4 mass %, and the B content contained in borosilicate particles in Sample 6 was 2.0 mass %.

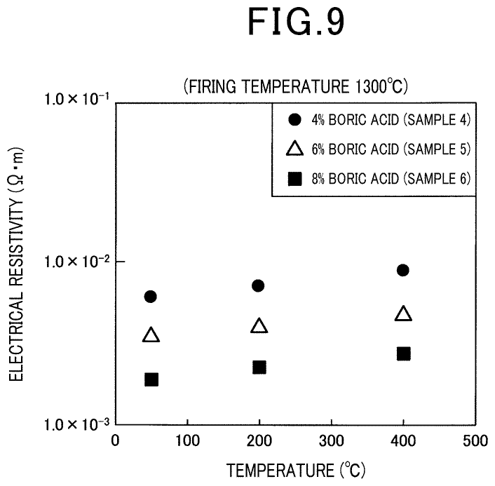

In the same manner as in Example 1, the electrical resistivity of each sample was measured, the results of which are shown in FIGS. 8 and 9. As shown in FIGS. 8 and 9, it was confirmed that as the firing temperature rises and as the amount of contained boric acid increases, the doping of boron to aluminoborosilicate is enhanced and the electrical resistivity is reduced.

The present disclosure is not limited to the embodiments and examples described above, and can be changed variously without departing from the gist thereof. The configurations described in the embodiments and examples can be freely combined. That is, although the present disclosure has been described with reference to the embodiments, it is to be understood that the present disclosure is not limited to the embodiments and structures. The present disclosure covers various modifications and variations within the scope of equivalents. In addition to various combinations and forms, other combinations and forms including one or more/less elements thereof are also within the spirit and scope of the present disclosure.

What is claimed is:

1. An electrical resistor comprising:
borosilicate particles;
Si-containing particles; and
pore parts constituted by gaps between the borosilicate particles and the Si-containing particles and surrounding the borosilicate particles and the Si-containing particles wherein
the electrical resistor has a cumulative pore volume of 0.05 ml/g or more.

2. The electrical resistor according to claim 1, wherein
the electrical resistor has an electrical resistivity of 0.0001 Ω·m or more and 1 Ω·m or less and an electrical resistance increase rate of 0/K or more and 5.0×10⁻⁴/K or less in a temperature range of 25 to 500° C.

3. The electrical resistor according to claim 1, wherein
the Si-containing particles are at least one type selected from a group consisting of Si particles, Fe—Si-based particles, Si—W-based particles, Si—C-based particles, Si—Mo-based particles, and Si—Ti-based particles.

4. The electrical resistor according to claim 1, wherein
in the borosilicate particles, a content of B atoms is 0.1 mass % or more and 5 mass % or less.

5. The electrical resistor according to claim 1, wherein
in the borosilicate particles, a total content of at least one type of alkali atom selected from a group consisting of Na, Mg, K, and Ca is 2 mass % or less.

6. The electrical resistor according to claim 1, wherein
the borosilicate particles are aluminoborosilicate particles.

7. The electrical resistor according to claim 1, wherein
the electrical resistor is configured to be used for a honeycomb structure in an electric heating catalytic device.

8. A honeycomb structure comprising
the electrical resistor according to claim 1.

9. A honeycomb structure comprising
the electrical resistor according to claim 1, wherein
the honeycomb structure has a particulate collection function.

10. An electric heating catalytic device comprising
the honeycomb structure according to claim 8.
